(19) United States
(12) Patent Application Publication
(10) Pub. No.: US 2017/0060094 A1
(43) Pub. Date: Mar. 2, 2017

(54) ANALOG DISPLAY DEVICE

(71) Applicant: CASIO COMPUTER CO., LTD., Tokyo (JP)

(72) Inventor: Yukari AIHARA, Tokyo (JP)

(73) Assignee: CASIO COMPUTER CO., LTD., Tokyo (JP)

(21) Appl. No.: 15/188,878

(22) Filed: Jun. 21, 2016

(30) Foreign Application Priority Data
Sep. 2, 2015 (JP) 2015-172635

(51) Int. Cl. G04B 19/26; G04B 19/04

(52) U.S. Cl. CPC G04B 19/262; G04B 19/04

(57) ABSTRACT

An analog display device, including: a hand; a dial plate which defines a pointing position of the hand; a measurement section which acquires a measurement value according to a determined measurement target; and a processor which moves the hand to a hand position between a first position and a second position which are defined on the dial plate, the hand position being determined according to the measurement value, wherein the processor sets a first setting value corresponding to the first position and a second setting value corresponding to the second position to be variable, and moves the hand to a relative hand position corresponding to a relative value of the measurement value with respect to the first setting value and the second setting value.

### BACKGROUND OF THE INVENTION

1. Field of the Invention

The present invention relates to an analog display device which performs analog display using hands.

2. Description of Related Art

Conventionally, there have been analog display devices which perform analog display of various contents by using hands. The analog display devices include devices which indicate predetermined mark positions according to acquired measurement values, operation types and such like, and devices which vary display contents according to variations of date and time and elapsed time.

There have been also analog display devices capable of performing display according to a calendar such as directions in which the sun and the moon can be seen. Japanese Unexamined Patent Application Publication No. 2003-502648 discloses a technique of indicating directions of sunrise and sunset for each season as a reference in a radial fashion from the rotation axis of hands in a timepiece which is capable of acquiring current date and time and current sun direction from the direction pointed by a hand which displays time by 24-hour display.

In addition, Japanese Patent Application Laid Open Publication No. 2011-122952 discloses an analog electronic timepiece which is capable of performing countdown display of remaining time to the sunrise or sunset time from a predetermined period of time before.

However, when hand display is simply performed by providing one or a plurality of fixed scale corresponding to the target of measurement display in an analog display device, the display contents, display range and hand operation range are limited, leading to even more difficulty in reading the results.

Especially in a compact analog display device such as a portable device, time is required to acquire measurement results due to rough scale or reading itself of the fine display becomes difficult. Thus, such analog display devices lack advantages over digital display devices including mobile devices such as smartphones which have been recently used with the analog display devices.

### SUMMARY OF THE INVENTION

In order to solve the above object, in the present invention, there is provided an analog display device which enables a user to acquire a trend of measurement result more sensuously and easily.

According to one aspect of the present invention, there is provided an analog display device, including: a hand which is rotatable; a dial plate which defines a pointing position of the hand; a measurement section which acquires a measurement value according to a determined measurement target; and a processor which moves the hand to a hand position between a first position and a second position which are defined on the dial plate, the hand position being determined according to the measurement value, wherein the processor sets a first setting value corresponding to the first position and a second setting value corresponding to the second position to be variable, and moves the hand to a relative hand position corresponding to a relative value of the measurement value with respect to the first setting value and the second setting value.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1 is an overall view of a display system in an embodiment of the present invention;

FIG. 2A is a plan view showing an enlarged view of small window display of an analog electronic timepiece;

FIG. 2B is a plan view showing an enlarged view of small window display of an analog electronic timepiece;

FIG. 3 is a block diagram showing a functional configuration of the analog electronic timepiece;

FIG. 4 is a block diagram showing a functional configuration of a smartphone;

FIG. 5 is a diagram showing an example of setting stored in a RAM of the analog electronic timepiece;

FIG. 6 is a sequence diagram showing a communication procedure between the analog electronic timepiece and the smartphone;

FIG. 7 is a flowchart showing a control procedure of setting update processing executed by the electronic timepiece;

FIG. 8 is a flowchart showing a control procedure of hand movement processing executed by the electronic timepiece;

FIG. 9 is a flowchart showing a control procedure of setting transmission processing executed by the smartphone;

FIG. 10 is a flowchart showing a control procedure of setting acquisition processing executed by the smartphone:

FIG. 11 is a block diagram showing a functional configuration of an electronic timepiece in a modification example 1;

FIG. 12 is a view showing a display example in a small window of the electronic timepiece in the modification example 1;

FIG. 13 is a block diagram showing a functional configuration of an electronic timepiece in a modification example 2;

FIG. 14 is a view showing a display example in a small window of the electronic timepiece in the modification example 2; and

FIG. 15 is a flowchart showing a control procedure of hand movement processing executed in the analog electronic timepiece of the modification example 2.

### DETAILED DESCRIPTION OF THE PREFERRED EMBODIMENT

Hereinafter, an embodiment of the present invention will be described with reference to the drawings.

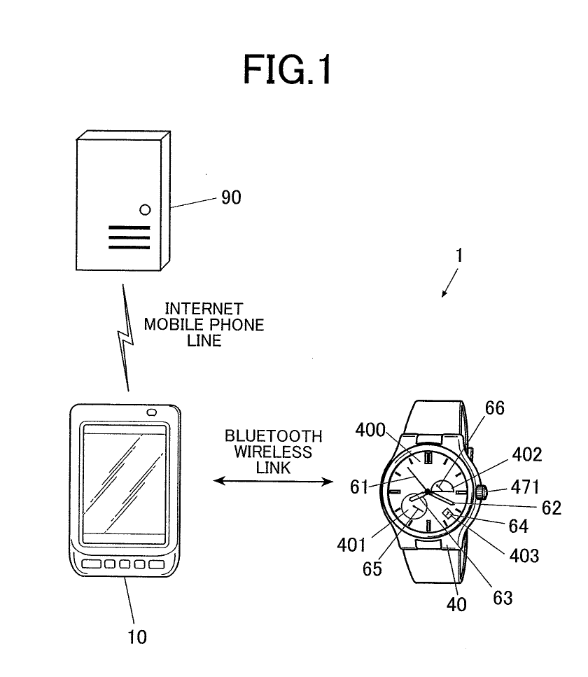

FIG. 1 is a view showing the entire configuration of a display system including an analog display device in the embodiment of the present invention.

The display system is configured by including an analog electronic timepiece 40 as an analog display device, a smartphone 10 as an external device and an external server 90.

Mutual data transmission and reception can be performed by communication connection of Near Field Communication using the Bluetooth (registered trademark) between the analog electronic timepiece 40 and the smartphone 10. The smartphone 10 can be connected to the external server 90 by the Internet via a wireless communication LAN or a mobile phone line.

The analog electronic timepiece 40 performs display according to date and time and predetermined functions by rotating a plurality of hands in a plane parallel to a dial plate 400. The dial plate 400 is provided with two small windows 401 and 402 and an opening 403. In the small window 401, a 24-hour hand 65 is rotated. The small window 402 exposes the range of 180 degrees of 12 o' clock side in a semicircle, and the rotation of small hand 66 (hand which is rotatable) can be visually confirmed in the exposed range. The opening 403 can selectively expose one of date marks indicating respective dates of “1” to “31” provided on the peripheral portion of a date wheel 64 according to the rotation of date wheel 64 which is a disk provided to be rotatable in a plane parallel to the dial plate. A second hand 61, minute hand 62 and hour hand 63 rotate on the dial plate 400 (front side of the analog electronic timepiece 40) around a nearly center of the dial plate 400 as a rotation axis.

Hereinafter, a part or all of the second hand 61, minute hand 62, hour hand 63, date wheel 64, 24-hour hand 65 and small hand 66 are also collectively referred to as hands 61 to 66, for example. From among them, the hands 61 to 65 are time hands for displaying date and time.

A crown 471 is provided on a lateral surface of the analog electronic timepiece 40 to allow pull operation and rotation operation.

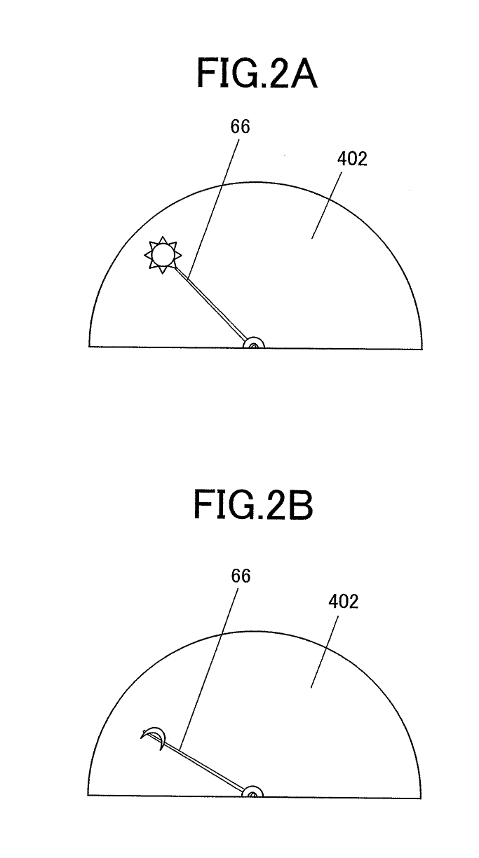

Each of FIGS. 2A and 2B is a plan view showing an enlarged view of the inside of small window 402.

A dial plate 4 (dial plate which defines a pointing position of hand) and the small hand 66 in the small window 402 are formed to be lowered by one level with respect to the dial plate 400 (covering plate). The operation of small hand 66 is exposed from the opening of dial plate 400 only in the range of 180 degrees on the 12 o'clock (reference location direction) side according to the date and time display by the hands 61 to 63, and the range of 180 degrees on the 6 o'clock side is covered in the back side of the dial plate 400. That is, the rotation plane of the small hand 66 is determined between the plane including the dial plate 400 and the plane including the dial plate 4 of small window 402. The small hand 66 has a mark in a shape indicating the sun at one end as shown in FIG. 2A, and has a mark in a shape indicating the moon at the other end as shown in FIG. 2B. The mark in a shape indicating the sun and the mark in a shape indicating the moon are provided in the 180-degree opposite sides (both ends) with respect to the rotation axis of the small hand 66, and one of the marks is selectively exposed over a range of a semicircle from the small window 402. Thus, daytime is indicated by the mark in a shape indicating the sun pointing to any position in the small window 402, and nighttime is indicated by the mark in a shape indicating the moon pointing to any position in the small window 402. The ends of the small hand 66 may be different in size (thickness), color, pattern, length from the rotation axis, combination thereof and such like in addition to or instead of the shape of marks as long as the daytime and nighttime can be extinguished. Alternatively, marks indicating the pointing positions may be printed on a rotatable disk instead of using the needle-like hand.

Here, the operation of small hand 66 is controlled so that the half of the mark indicating the sun appears from the 9 o'clock direction in the small window 402 at the timing of sunrise time (first setting value, start time) and the half of the mark disappears from the 3 o'clock direction outside the small window 402 (under the dial plate 400) at the timing of sunset time (second setting value, end time) regardless of the actual sunrise time and sunset time. By this operation control, a relative degree of time elapse (elapsed time from the start time) during the daytime or the nighttime is constantly displayed regardless of the time ratio of daytime and nighttime. That is, the straight line of the semicircle small window 402 defines the position (first position) corresponding to sunrise time and the position (second position) corresponding to sunset time which is 180-degree opposite to the first position with respect to the rotation axis of small hand 66.

The external server 90 is a database server (computer) which can be accessed from outside via the Internet by using various protocols such as HTTP.

The external server 90 includes a database storage section and stores all of the latest time zone information and summer time implementation information (whether or not to implement summertime, implementation period and shift time for the implementation) for cities (areas) in the world which can be set in the analog electronic timepiece 40. The database storage section stores estimated sunrise times and sunset times for the immediate following days in each of the cities so as to be associated with the city, and this information can be acquired by the smartphone 10 via the Internet.

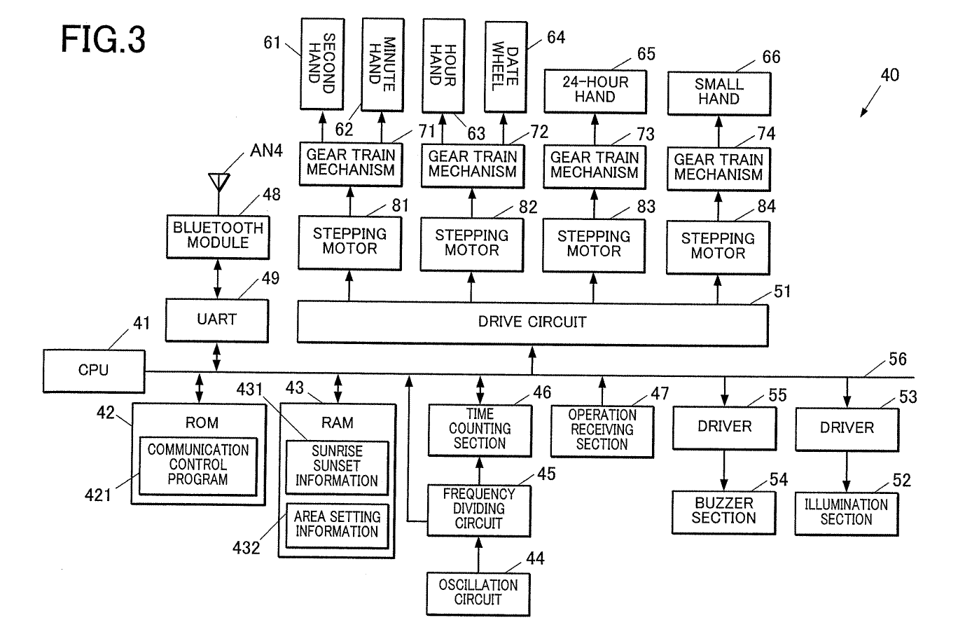

FIG. 3 is a block diagram showing the functional configuration of the analog electronic timepiece 40.

The analog electronic timepiece 40 is an electronic timepiece which can perform display according to date and time and predetermined functions by electrically rotating a plurality of hands. The analog electronic timepiece 40 includes: a CPU (Central Processing Unit) 41; a ROM (Read Only Memory) 42; a RAM (Random Access Memory) 43; an oscillation circuit 44; a frequency dividing circuit 45; a time counting section 46 (time counting section); an operation receiving section 47; a Bluetooth module 48 (communication section); an antenna thereof AN4; a UART (Universal Asynchronous Receiver/Transmitter) 49; a drive circuit 51; an illumination section 52; a driver thereof 53; a buzzer section 54; a driver thereof 55; the second hand 61; the minute hand 62; a stepping motor 81 which rotates the second hand 61 and the minute hand 62 via a gear train mechanism 71; the hour hand 63; the date wheel 64; a stepping motor 82 which rotates the hour hand 63 and the date wheel 64 via a gear train mechanism 72; the 24-hour hand 65; a stepping motor 83 which rotates the 24-hour hand 65 via a gear train mechanism 73; the small hand 66; a stepping motor 84 which rotates the small hand 66 via a gear train mechanism 74; a bus 56 and such like.

The CPU 41 is a processor which performs various arithmetic processing and integrally controls the entire operation of the analog electronic timepiece 40. The CPU 41 reads out various programs according to the operation of analog electronic timepiece 40 from the ROM 42 and executes the programs.

The ROM 42 stores various control programs and initial setting data according to operation of analog electronic timepiece 40. The control programs include a communication control program 421 for communicating with the smartphone 10. The ROM 42 may include a rewritable non-volatile memory in addition to a mask ROM.

The RAM 43 provides a working memory space to the CPU 41, and stores temporary data. The temporary data stored in the RAM 43 includes area setting information 432 regarding area setting including information regarding the current position (city, area and a predetermined position), local time setting to which the current position belongs and such like, and sunrise sunset information 431 regarding the sunrise and sunset times of at least the immediate following day at the current position. As the RAM 43, a volatile memory such as a DRAM which is inexpensive and capable of high speed reading and writing is mainly used. However, the RAM 43 may include a SRAM and may also include a non-volatile memory capable of high speed operation.

The area setting information 432 includes local time setting at the current position. The local time setting includes information regarding a city or an area set as the current position, information according to the time zone to which the city or the area belongs, and information regarding implementation of summer time at the city.

The sunrise sunset information 431 includes the sunrise time and sunset time for at least the immediate following day at the current position. The information stored as the sunrise sunset information 431 may be information for a plurality of days, and is appropriately determined according to the memory capacity and such like. When the current position, that is, the city or area set in the area setting information 432 is changed, the sunrise sunset information 431 is entirely initialized and newly acquired.

When a time zone is broad, there are largely different sunrise times and sunset times in the same time zone in some cases. Thus, the city or area and the sunrise time and sunset time thereof do not need to be determined uniquely with respect to one time zone and one area applying a summer time implementation rule. There may be set more detailed cities and areas and sunrise times and sunset times according to the cities and areas.

The oscillation circuit 44 generates and outputs a predetermined frequency signal. The frequency dividing circuit 45 divides the frequency output from the oscillation circuit 44 into appropriate frequency signals to be used in the analog electronic timepiece 40, and outputs the signals.

The time counting section 46 is a counter which counts and stores current date and time by counting the signal inputs from the frequency dividing circuit 45 and adding the number of inputs to initial date and time data. The time counting section 46 is not limited to a counter as a hardware configuration, and may be a configuration in which the current date and time counted by software under the control of CPU 41 is stored in a RAM. The RAM may be identical to the RAM 43, or another RAM may be separately provided.

The time counting section 46 may count a unique count value which can be converted into the current date and time such as UTC (Universal Time Coordinated) on the basis of a predetermined reference, convert the date and time into the UTC date and time or local time in the city set as the current position, and acquire the converted date and time as needed. Alternatively, the time counting section 46 may directly count the UTC date and time or the local time of the current position. The current date and time counted by the time counting section 46 can be modified by a control signal from the CPU 41.

The operation receiving section 47, which has the crown 471 as a mechanism for receiving the input from outside, generates an electrical signal corresponding to the input operation by a user and outputs the signal as an input signal to the CPU 41. The user s operation to the operation receiving section 47 enables switching of DST setting and change of city setting in a world time clock, for example. As the operation receiving section 47, an operation mechanism such as a push button switch may be provided instead of or in addition to the crown 471.

The Bluetooth module 48 is a control module for performing communication by the Bluetooth with an external device such as the smartphone 10 via the antenna AN4. The transmission data transmitted from the CPU 41 is subjected to processing such as serial/parallel conversion at the UART 49, and transmitted from the Bluetooth module 48 to the external device. The reception data received by the antenna AN4 and the Bluetooth module 48 is subjected to processing such as the serial/parallel conversion and such like at the UART 49 and output to the CPU 41.

The illumination section 52 illuminates the dial plate of analog electronic timepiece 40 according to the drive voltage which was output from the driver 53 by the control signal from the CPU 41. As the illumination section 52, an LED (light emitting diode) is used, for example. The buzzer section 54 generates buzzer sound (beep sound) according to a drive signal output from the driver 55 by the control signal from the CPU 41. As a mechanism for generating buzzer sound, there may be used a method of vibrating metal plate according to the voltage applied to piezoelectric element by combining the piezoelectric element and the metal plate, for example.

The drive circuit 51 outputs drive signals for rotating the hands 61 to 66 at timings, lengths and voltage amplitudes which are appropriate for the stepping motors 81 to 84 on the basis of the control signal from the CPU 41.

In the stepping motors 81 to 84, rotors are rotated with respect to the respective stators by predetermined angles (for example, 180 degrees) according to the drive signals from the drive circuit 51, to rotate by predetermined angles the respective gears of the gear train mechanisms 71 to 74 which are gear trains for rotating the hands 61 to 66. Here, for example, the stepping motor 81 rotates the second hand 61 by 6 degrees for one rotation of rotor, the stepping motors 82 to 84 respectively rotate the hour hand 63, 24-hour hand 65 and small hand 66 by 1 degree (predetermined angle) for one rotation of rotor. The minute hand 62 rotates in conjunction with the second hand 61 with the rotation angle ratio of 1:60. The date wheel 64 rotates, though not especially limited, only within the predetermined 120-degree rotation angle (e.g. from 10 o'clock to 2 o'clock) during the two rotations (720 degrees) of the hour hand 63, and rotates 3/31 degree for each movement and a total of 360/31 degree rotation during the 120 degree rotation. The date marks showing the numbers “1” to “31” are provided at the interval of 360/31 degree on the peripheral portion of the date wheel 64, and one of the date marks is exposed to indicate the date from the opening 403 provided in the dial plate 400. The stepping motors 81 to 84 can rotate the hands 61 to 66 in both of the forward direction (clockwise, predetermined rotation direction) and backward direction (counterclockwise).

The bus 56 is a signal path for transmitting signals between the CPU 41 and the respective sections.

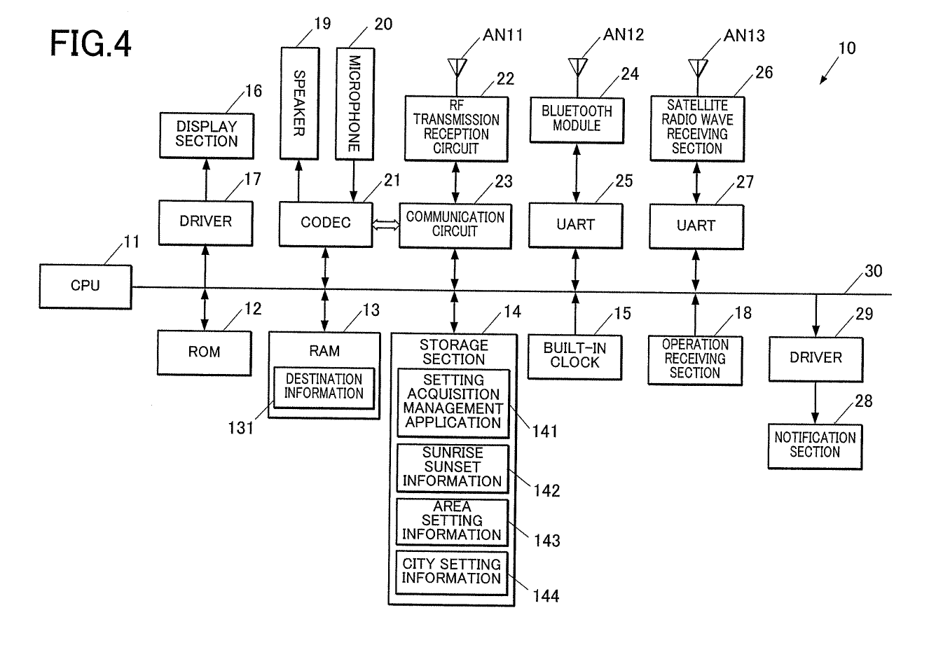

FIG. 4 is a block diagram showing the functional configuration of smartphone 10.

The smartphone 10 includes a CPU 11, a ROM 12, a RAM 13, a storage section 14, a built-in clock 15, a display section 16, a driver thereof 17, an operation receiving section 18, a speaker 19, a microphone 20, a codec 21, an RF transmission reception circuit 22, an antenna AN11 for transmitting and receiving RF communication radio waves, a communication circuit 23, a Bluetooth module 24, a UART 25, an antenna AN12 for transmitting and receiving communication radio waves by the Bluetooth, a satellite radio wave receiving section 26, an antenna AN 13 for receiving radio waves of positioning satellite, a UART 27, a notification section 28, a driver thereof 29, a bus 30 and such like.

The CPU 11 performs various types of arithmetic processing, and integrally controls the entire operation of smartphone 10. The CPU 11 acquires the current position calculated on the basis of the radio waves received by the satellite radio wave receiving section 26 from the positioning satellite, or the CPU 11 identifies the current position of smartphone 10 on the basis of the information regarding a base station of mobile telephone communication connected to the RF transmission reception circuit 22. The CPU 11 acquires setting information (area setting information and sunrise sunset information) of the analog electronic timepiece 40 from the external server 90 periodically or at a necessary timing by a setting acquisition management application 141, stores the setting information, and transmits the setting information to the analog electronic timepiece 40 when the smartphone 10 and the analog electronic timepiece 40 are connected to each her via Bluetooth communication.

The ROM 12 stores various programs to be executed by the CPU 11 and initial setting data. At least a part of the ROM 12 may be a rewritable non-volatile memory.

The RAM 13 is a volatile memory which provides a working memory space to the CPU 11 and stores temporary working data. By storing information regarding the analog electronic timepiece 40 which is a destination of communication connection via the Bluetooth as destination information 131 in the RAM 13, appropriate data can be transmitted to the analog electronic timepiece 40 promptly.

The storage section 14 includes a non-volatile memory capable of reading and rewriting/updating such as a flash memory and an EEPROM (Electrically Erasable and Programmable Read Only Memory), for example. The data stored in the storage section 14 includes the setting acquisition management application 141, sunrise sunset information 142, area setting information 143 and city setting information 144. The CPU 11 reads out and executes the setting acquisition management application 141, updates the area setting information 143 according to local time setting and the sunrise sunset information 142 according to sunrise and sunset times at the current position, and transmits the updated data to the analog electronic timepiece 40 when the smartphone 10 is communicably connected to the analog electronic timepiece 40 via the Bluetooth. Accordingly, after transmitting the updated data to the analog electronic timepiece 40, the area setting information 143 and sunrise sunset information 142 can be identical to the area setting information 432 and the sunrise sunset information 431, respectively. Alternatively, the updated data to be transmitted to the analog electronic timepiece 40 may be a necessary part in the area setting information 143 and the sunrise sunset information 142. For example, the area setting information 143 and the sunrise sunset information 142 may include past setting history information and such like.

The city setting information 144 is table data identifying the time zone to which the current position belongs, summer time implementation rule setting area, and cities or area names which belong to the time zone and the summer time implementation rule setting area on the basis of latitude and longitude of the current position acquired by the satellite radio wave receiving section 26. The table data includes, for example, map data and a comparison table, the map data storing identification numbers indicating cities (area names) according to time zones and summer time implementation rule setting areas which belong to respective meshes divided at the interval of predetermined latitude and longitude, and the comparison table associating the identification numbers with city names. Instead of storing the city setting information 144 in the smartphone 10, the values of latitude and longitude may be transmitted to the external server 90 so as to allow the acquisition of information regarding the corresponding city from the external server 90.

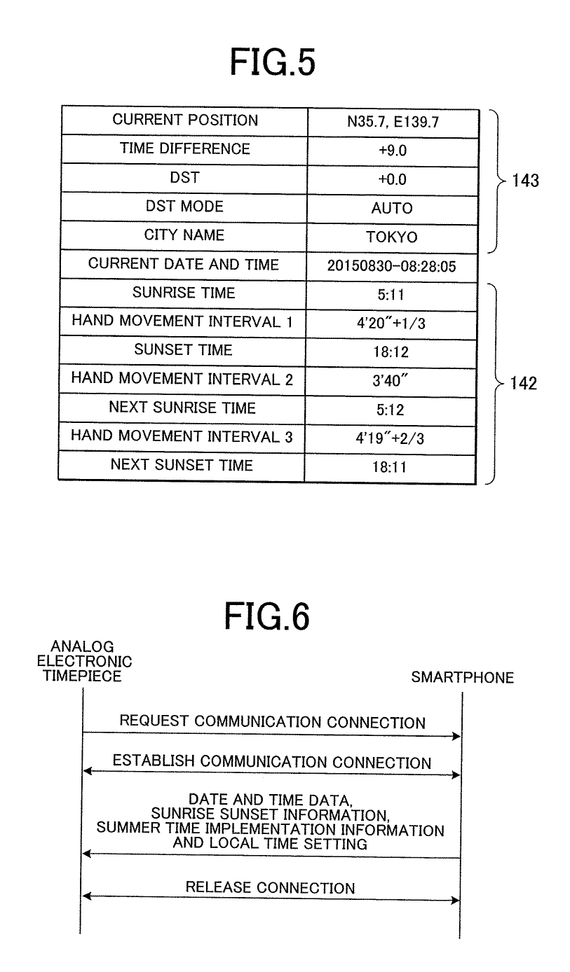

FIG. 5 is a diagram showing an example of setting information stored in the storage section 14.

The storage section 14 stores the latitude and longitude of the current position acquired from the satellite radio wave receiving section 26, and stores settings as the area setting information 143, the settings including time difference information, shift time information according to whether or not to implement summer time and summer time application setting information of the time zone corresponding to the current position, and representative city information of the time zone. The current local time based on these settings is converted and calculated from the date and time of the built-in clock 15.

In addition, the sunrise time and sunset time corresponding to the area setting information 143 and the hand movement interval of small hand 66 between adjacent sunrise time and sunset time are stored as sunrise sunset information 142. In the area setting information 143, the sunrise time, sunset time and hand movement interval can be stored not only for the current day but also for a predetermined number of times. The sunrise time and sunset time may be stored every several days, for example, at intervals of five days, and the sunrise times and sunset times of the dates in the interval may be calculated by linear interpolation. When the calculated hand movement interval has a fractional part, adjustment may be performed each time the accumulated fractional parts exceed a predetermined period of time, for example, one second. Alternatively, the timing deviation within approximately one minute may be allowed in consideration of the use state of analog electronic timepiece 40 not requiring very accurate display for the design thereof, the difference between the current position determined based on the time zone setting and such like and the accurate current position, a gap caused by the altitude and horizon shape at the current position and such like.

The built-in clock 15 is a counter which counts and stores the current date and time. The current date and time may be counted by software by the operation of CPU 11 and stored in the RAM and such like. The built-in clock 15 has an RTC (Real Time Clock), and when the smartphone 10 is activated again after being turned off, the date and time data is acquired from the RTC and counting is started again. In the smartphone 10, the current date and time in the built-in clock 15 is read out, the local time is calculated according to time zone and summer time implementation setting as needed, the calculated data is displayed on the display section 16 and used for various processing, and the current date and time is compared with setting time according to various functions to perform various operations. At the time of communication with the base station of mobile telephone communication by the RF transmission reception circuit 22, the current date and time data of the built-in clock 15 corrected by time data which is acquired from the base station as needed.

The display section 16 includes a display screen performing various displays. As the display screen, a liquid crystal display (LCD) is used, for example. The driver 17 (liquid crystal driver) which operates by the control signal transmitted from the CPU 11 drives the LCD according to the control signal to perform display according to various functions on the display screen. The display section 16 may include a display screen of other display types, for example, an organic ELD (Electro-Luminescent Display), and the driver 17 is appropriately selected according to the display type of the display screen.

The operation receiving section 18, which includes a touch panel, detects the touched position and operation content of user's touch operation to the touch panel that is superposed on the display screen of the display section 16, generates an electrical signal corresponding to the operation, and outputs the signal as an input signal to the CPU 11. The operation receiving section 18 may further include one or a plurality of operation key and switch (push button switch and slide switch, for example), and output an input signal based on user's operation to the operation key or switch to the CPU 11.

The speaker 19 converts the electrical signal into a sound signal on the basis of the signal from the codec 21, and outputs the sound. The microphone 20 detects sound waves to convert the waves to an electrical signal, and outputs the converted signal to the codec 21. The codec 21 decodes an encoded and compressed digital sound signal, transmits the decoded signal as an analog signal to the speaker 19 and encodes the sound signal acquired from the microphone 20 to output the signal to the CPU 11 and communication circuit 23. The speaker 19 may separately include a speaker for talk and a speaker for outputting ringtone, operation sounds and such like outside.

The RF transmission reception circuit 22 transmits and receives signals according to telephone communication and data communication with the base station of mobile telephone communication via the antenna AN11. The communication circuit 23 performs various types of processing according to transmission reception data transmitted and received by the RF transmission reception circuit 22, and performs data transmission with the CPU 11 and codec 21. The RF transmission reception circuit 22 is connected to the access point of wireless LAN, and can perform data transmission and reception (data communication) with each point on the Internet including the external server 90 via the wireless LAN.

The Bluetooth module 24 is a control module for communication by the Bluetooth with an external device such as the analog electronic timepiece 40 via the antenna AN12 The transmission data transmitted from the CPU 11 is subjected to processing such as serial/parallel conversion at the UART 25, and the processed data is transmitted from the Bluetooth module 24 to the external device. The reception data which was received from the external device by using the Bluetooth module 24 is subjected to processing such as parallel/serial conversion at the UART 25 and output to the CPU 11.

The satellite radio wave receiving section 26 receives radio waves of L1 band (1.57542 GHz for GPS satellite) from a plurality of positioning satellites, mainly from GPS (Global Positioning System) satellite via the antenna AN13, and reads signals (navigation message) to calculate the current position. The calculated current position, additional information according to the calculation and such like are output to the CPU 11 via the UART 27 in a predetermined format.

The notification section 28 performs a predetermined notification operation. As the notification section 28, vibration motor using a rotation motor, an LED lamp, a piezoelectric element and a vibration plate generating beep sound are used, for example. When a control signal is transmitted from the CPU 11 to the driver 29, the driver 29 converts the signal into a voltage signal necessary for operating the notification section 28, and outputs the converted signal.

The bus 30 is a data path for transmitting and receiving a signal between the CPU 11 and other components in the smartphone 10.

Next, the operation of acquiring setting information and sunrise sunset display operation by the analog electronic timepiece 40 in the embodiment will be described.

The analog electronic timepiece 40 in the embodiment calculates relative elapse degree of the current time (relative value of current time with respect to sunrise time and sunset time) during daytime or nighttime according to the information regarding sunrise time and sunset time acquired from the smartphone 10, and makes the small hand 66 point to the hand position (relative hand position) corresponding to the relative value within a range of the fixed small window 402.

FIG. 6 is a sequence view showing transmission and reception of setting data between the analog electronic timepiece 40 and the smartphone 10.

First, the analog electronic timepiece 40 requests communication connection to the smartphone 10, and establishes the communication connection by the Bluetooth with the smartphone 10. The smartphone 10 then transmits the sunrise sunset information 142 and the area setting information 143 (that is, time zone information and summer time implementation information) together with the current date and time data to the analog electronic timepiece 40. When the analog electronic timepiece 40 receives the data, the analog electronic timepiece 40 releases the communication connection with the smartphone 10.

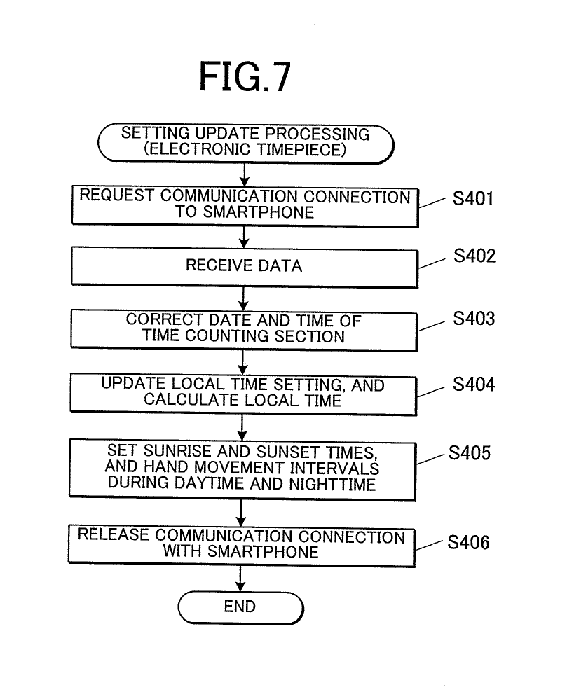

FIG. 7 is a flowchart showing a control procedure by the CPU 41 of setting update processing which is executed by the analog electronic timepiece 40.

The setting update processing is automatically activated and executed at preset time once a day (at a predetermined setting interval) in the analog electronic timepiece 40.

When the setting update processing is activated, the CPU 41 activates the Bluetooth module 24, receives broadcast from the smartphone 10 and transmits a request for communication connection to the smartphone 10 (step S401). When the communication connection is established, the CPU 41 waits for the transmission of setting data from the smartphone 10, and receives the setting data (step S402).

The CPU 41 corrects the date and time counted by the time counting section 46 on the basis of the acquired current date and time (step S403). The CPU 41 stores the received area setting information, that is, the time zone information and summer time implementation information according to the local time setting as the area setting information 432 to enable the calculation of local time based on the setting information (step S404).

The CPU 41 stores the received sunrise sunset information, that is, the sunrise time, sunset time, hand movement interval of small hand 66 during daytime (first hand movement interval) and hand movement interval of small hand 66 during nighttime (second hand movement interval) as the sunrise sunset information 431 (step S405). The hand movement intervals may be calculated by the CPU 41 on the basis of the received sunrise and sunset times, and hand movement step information of the small hand 66. The CPU 41 releases the communication connection with the smartphone 10 (step S406), and ends the setting update processing.

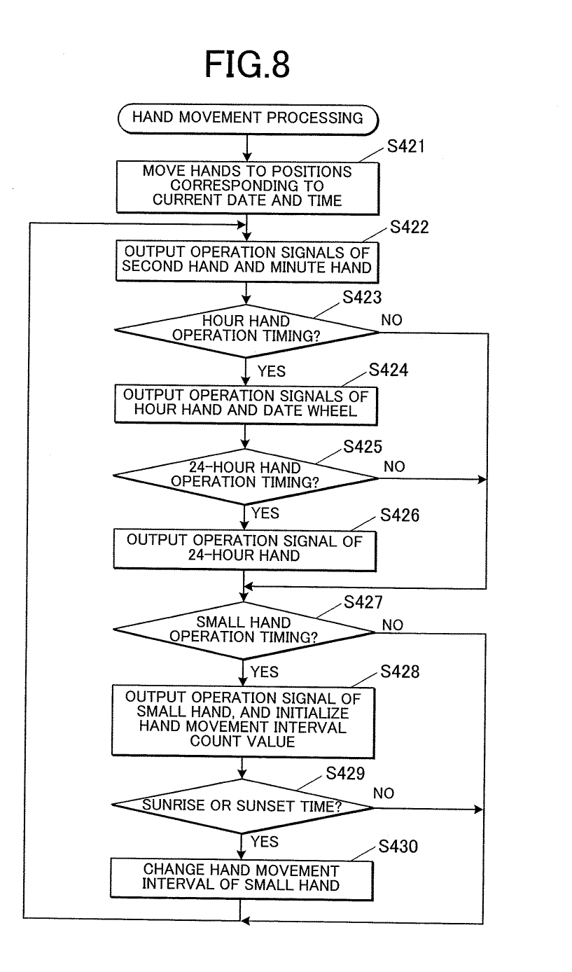

FIG. 8 is a flowchart showing a control procedure of hand movement processing according to date and time display state in the analog electronic timepiece 40.

The hand movement processing is invoked in the date and time display state and continuously executed. When the hand movement processing is started, the CPU 41 outputs a control signal to the drive circuit 51 to move the hands 61 to 66 to the respective positions corresponding to the current date and time (step S421).

The CPU 41 outputs a control signal for driving the stepping motor 81 according to the second hand 61 and the minute hand 62 to the drive circuit 51 at the movement timing of the hands 61 and 62 (step S422). The CPU 41 determines whether the present time is the operation timing of the hour hand 63 (step S423), and if it is not determined that the present time is the operation timing (step S423: NO), the processing proceeds to step S427.

If it is determined that the present time is the operation timing of the hour hand 63 (step S423: YES), the CPU 41 outputs the control signal to the drive circuit 51 to drive the stepping motor 82 (step S424). Next, the CPU 41 determines whether the present time is the operation timing of the 24-hour hand 65 (step S425). If it is not determined that the present time is the operation timing of the 24-hour hand 65 (step S425: NO), the processing proceeds to step S427. If it is determined that the present time is the operation timing of the 24-hour hand 65 (step S425: YES), the CPU 41 outputs a control signal to the drive circuit 51 to drive the stepping motor 83 (step S426), and the processing proceeds to step S427.

When the processing proceeds from any one of steps S423, S425 and S426 to step S427, the CPU 41 determines whether the present time is the operation timing of small hand 66 (step S427) The CPU 41 counts the elapsed time (hand movement interval count value) from the previous operation timing of small hand 66. If it is not determined that the present time is the operation timing of small hand 66, that is, if it is determined that the elapsed time is shorter than the hand movement interval (step S427: NO), the processing of CPU 41 returns to step S422.

If it is determined that the present time is the operation timing of small hand 66, that is, if it is determined that the elapsed time from the previous operation timing is equal to the hand movement interval (step S427: YES), the CPU 41 outputs a control signal to the drive circuit 51 to drive the stepping motor 84 for rotating the small hand 66, and initializes the elapsed time from the previous operation timing of small hand 66 to start counting from “0” again (step S428). The CPU 41 determines whether or not the current date and time is the sunrise time or sunset time (step S429) If it is not determined that the current date and time is the sunrise time or sunset time (step S429: NO), the processing of CPU 41 returns to step S422. If it is determined that the current date and time is the sunrise time or sunset time (step S429: YES), the CPU 41 refers to the sunrise sunset information 431 and changes the hand movement interval to the hand movement interval for moving the small hand 66 until the next sunrise or sunset time (step S430). Then, the processing of CPU 41 returns to step S422.

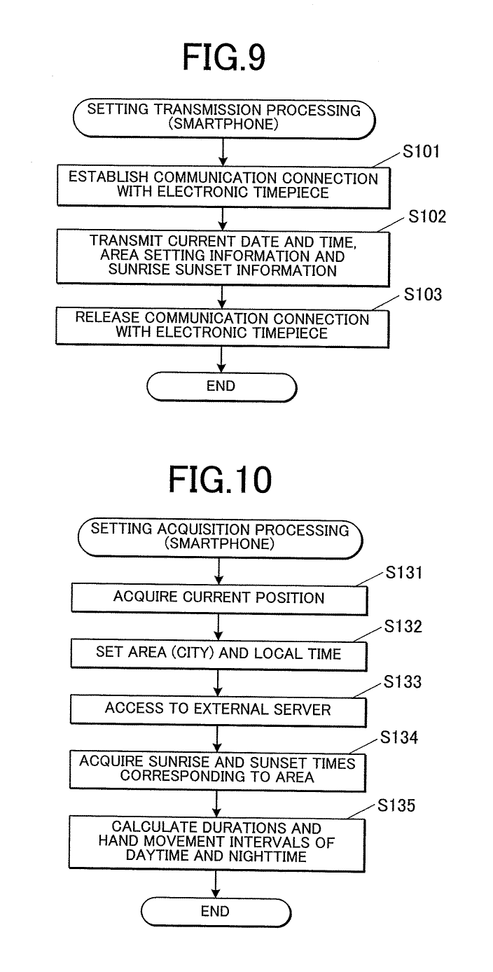

FIG. 9 is a flowchart showing a control procedure by the CPU 11 of setting transmission processing executed in the smartphone 10.

The setting transmission processing is activated when the reception of communication connection request from the analog electronic timepiece 40 is detected in a state in which the Bluetooth module 24 is transmitting the broadcast.

When the setting transmission processing is activated, the CPU 11 performs processing of establishing the communication connection with the analog electronic timepiece 40 (step S101). Then, the CPU 11 transmits the current date and time, area setting information and sunrise sunset information to the analog electronic timepiece 40 (step S102) The CPU 11 releases the communication connection with the analog electronic timepiece 40 according to the request from the analog electronic timepiece 40 (step S103), and ends the setting transmission processing.

FIG. 10 is a flowchart showing a control procedure by the CPU 11 of setting acquisition processing executed in the smartphone 10.

The setting acquisition processing is activated at preset time once a day and when the current position acquired from the satellite radio wave receiving section 26 and the mobile phone base station changes by more than a predetermined reference distance, for example.

The CPU 11 first acquires the current position acquired from the satellite radio wave receiving section 26, mobile telephone base station and such like (step S131). When a predetermined period of time or more elapses from the previous current position acquisition, the CPU 11 performs the acquisition operation of current position at this timing.

The CPU 11 acquires the city corresponding to the time zone of the current position by referring to the city setting information 144 (step S132). The CPU 11 accesses the external server 90 (step S133), and acquires the sunrise time and sunset time corresponding to the acquired city (area) (step S134). The CPU 11 calculates respective durations of daytime and nighttime from the acquired sunrise and sunset times, calculates the hand movement intervals of small hand 66 corresponding to the respective durations, and stores the intervals as the sunrise sunset information 142 (step S135). Then, the CPU 11 ends the setting acquisition processing.

As described above, the analog electronic timepiece 40 in the embodiment includes: a small hand 66 which is rotatable; a dial plate 4 which defines pointing positions of small hand 66; a time counting section 46 as a measurement section which acquires a measurement value (current time and elapsed time) according to a determined measurement target; and a CPU 41 as a processor. The CPU 41 moves the small hand 66 to a hand position determined according to the measurement value between the predetermined first position (9 o'clock position) and second position (3 o'clock position) defined on the dial plate 4. The CPU 41 sets the sunrise time (first setting value) corresponding to the first position and sunset time (second setting value) corresponding to the second position to be variable, and moves the small hand 66 to the relative hand position corresponding to the relative value of the current time with respect to the sunrise time and sunset time in a state in which specific sunrise time and sunset time are not indicated.

Accordingly, the user can sensuously and easily acquire the trend of measurement result by the direction indicated by the small hand 66 between the 9 o'clock position and the 3 o'clock position in the small window 402 without depending on specific sunrise time and sunset time varying by the season.

Especially, in a case where the analog electronic timepiece 40 is a timepiece such as an electronic wristwatch in which the display section is small, the display on the dial plate 4 is not compressed and the freedom degree of design is not lowered since specific sunrise time and sunset time are not displayed. Since the time from the sunrise to the sunset can be displayed without changing the size and shape of small window 402, the stepping motor according to the change operation of small window 402 can be omitted, thus allowing the reduction of size of analog electronic timepiece 40 and the use of stepping motor for other functions.

The measurement section includes the time counting section 46 which counts the current date and time. The first setting value is predetermined start time, the second setting value is predetermined end time, and the measurement target is the elapsed time from the start time. The CPU 41 calculates a first drive interval for moving the small hand 66 by a predetermined angle (here, 1 degree), and moves the small hand 66 from the first position (9 o'clock position) by the predetermined angle at the first drive interval from the start time. By displaying, with the small hand 66, the relative elapsed amount of the elapsed time having a time limit and such like in such way, the time allocation state in the whole can be acquired easily.

The small hand 66 can rotate in at least the forward direction (clockwise direction) in the small window 403 of the dial plate 400, and the CPU 41 calculates the second drive interval of moving the small hand 66 from the second position (3 o' clock position) to the first position (9 o' clock position) in the forward direction by the predetermined angle (1 degree) from the end time (second setting value) to next start time (first setting value), that is, from the sunset time to the next sunrise time, and moves the small hand 66 by the predetermined angle (1 degree) at the second drive interval from the end time.

Accordingly, for a phenomenon such as sunrise and sunset repeating every day, the hand can be effortlessly moved to the sunrise position before the start of count display of next day. Furthermore, unnecessary operations of small hand 66 is not noticeable in the small window 403.

The dial plate 400 functions as a covering plate which is provided with an opening partially exposing the dial plate 4 and the small hand 66 in the upper (12 o' clock side) half of a circle, and the rotation of the small hand 66 in the forward direction from the first position (9 o' clock position) to the second position (3 o' clock position) is exposed from the small window 402 as the opening.

Thus, since display can be performed for only the necessary period from sunrise to sunset, the relative range can be understood easily and clearly and the relative elapsed time can be easily acquired in the relative range.

Since the small window 402 is not allocated for the part which does not need to be displayed, the space for the dial plate 4 is saved and the saved space can be used for design expansion.

Since the start time is the sunrise time at the current position and the end time is sunset time at the current position, the user can acquire the time elapse degree during the daytime and nighttime sensuously and easily according to the user's common sense without depending on specific sunrise time and sunset time.

Since the first position and the second position are respectively determined to be located on the 180-degree opposite sides, the user can acquire the relative degree of measurement value more sensuously and easily.

The start time is set in 9 o' clock direction with respect to the sunrise time at a predetermined position (current position) based on 12 o' clock direction of the dial plate 4 as a reference, and the second position is set in 3 o'clock direction based on the 12 o'clock direction as a reference. Thus, the relative time elapse from sunrise to sunset can be expressed so as to be acquired more sensuously. Especially, by using such display for expression of sunrise and sunset, the expression can be more recognizable following user's sense according to the movement of the sun.

The small hand 66 has ends pointing to respective two points in the 180-degree opposite sides with respect to the rotation axis of the small hand 66, and the ends has decorations in different shapes, here the sun shape and moon shape. Thus, one end is located outside the small window 402 while the other end is located in the small window 402, and whether or not an end is located in the small window 402 can be easily acquired. Thus, elapse degree of each time can be acquired easily for a repeated combination of operation such as daytime and nighttime, and work time and break time.

The analog electronic timepiece 40 includes a Bluetooth module 48 which performs communication with an external device such as the smartphone 10, and the CPU 41 acquires the first setting information and the second setting information from the smartphone 10 via the Bluetooth module 48.

Since the setting information is acquired from an external device which is easier to operate and higher in processing capability, troublesome setting by the analog electronic timepiece 40 itself can be reduced. Furthermore, since necessary information is acquired as needed by the smartphone 10 from an external server 90 and such like, the range of expression can be extended without bothering the user.

The sunrise time (first setting value) and sunset time (second setting value) vary every day according to the time elapse, and the CPU 41 automatically acquires the first setting value and the second setting value from the smartphone 10 via the Bluetooth module 48 at a predetermined timing once a day, that is, at the interval of 24 hours.

Thus, the latest sunrise time and sunset time corresponding to the date are acquired easily and surely, and the relative elapse state of daytime and night time is appropriately displayed to enable the user acquire the state even when the user has no concern with the routine setting operation at all.

The above-mentioned display can be performed in the electronic timepiece including hands 61 to 65 which are time hands displaying the current date and time. Thus, the electronic timepiece can be used as a device extending the range of expression, not only used as a tool for accurately displaying date and time.

### Modification Example 1

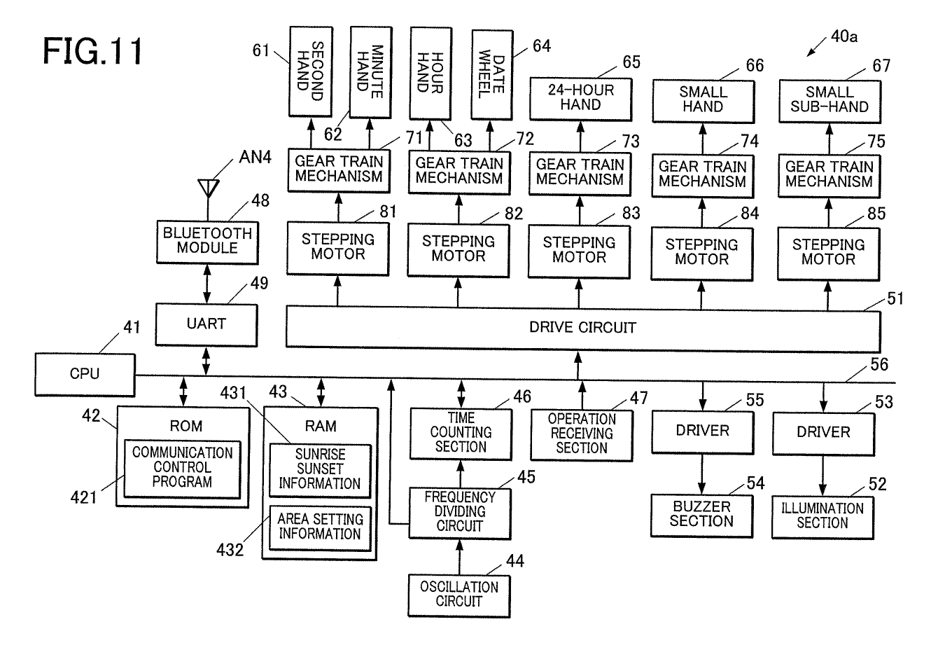

FIG. 11 is a block diagram showing the functional configuration of an analog electronic timepiece 40a in a modification example 1.

The analog electronic timepiece 40a has the same configuration as that of the analog electronic timepiece 40 in the above-mentioned embodiment except for that the analog electronic timepiece 40a further includes a small sub-hand 67 and a stepping motor 85 which rotates the small sub-hand 67 via a gear train mechanism 75. Thus, same reference numerals are provided to the same components to omit the explanation thereof.

The analog electronic timepiece 40a in the modification example 1 has a world clock function of displaying local time at any area in the world in addition to the local time at the current position by using the 24-hour hand 65. The small sub-hand 67 is provided with the both ends respectively having a mark in sun shape indicating daytime and a mark in moon shape indicating nighttime similarly to the small hand 66, and can perform display according to sunrise and sunset in an area which was set as a display area of the world clock in the same small window 402 displaying the small hand 66. Accordingly, the small hand 66 and the small sub-hand 67 are formed so as to be distinguishable regarding which is corresponding to the current position and which is corresponding to the world clock, and the small sub-hand 67 is formed to be smaller than the small hand 66, for example.

The sunrise sunset information according to the operation of small sub-hand 67 is acquired from the smartphone 10 and stored as sunrise sunset information 431 similarly to the sunrise sunset information according to the operation of small hand 66. The operation of small sub-hand 67 is controlled by the CPU 41 on the basis of the sunrise sunset information 431 similarly to the small hand 66. Accordingly, the detailed description regarding the control operation is omitted.

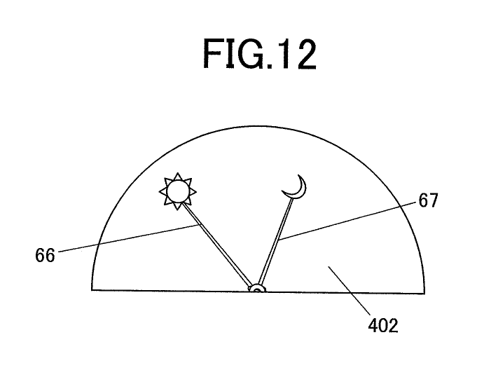

FIG. 12 is a view showing a display example inside the small window 402 by the small hand 66 and the small sub-hand 67.

The operations of small hand 66 and the small sub-hand 67 are controlled independently from each other on the basis of the current position and the position according to the world clock, respectively. Accordingly, depending on the positional relationship between the current position and the setting position according to the world clock, the date and time (season) and such like, there can be a case where the drive interval for the sun-side end or the moon-side end is largely different between the small hand 66 and the small sub-hand 67 in the small window 402 and one hand goes past the other hand.

### Modification Example 2

Next, an analog electronic timepiece 40b in a modification example 2 will be described.

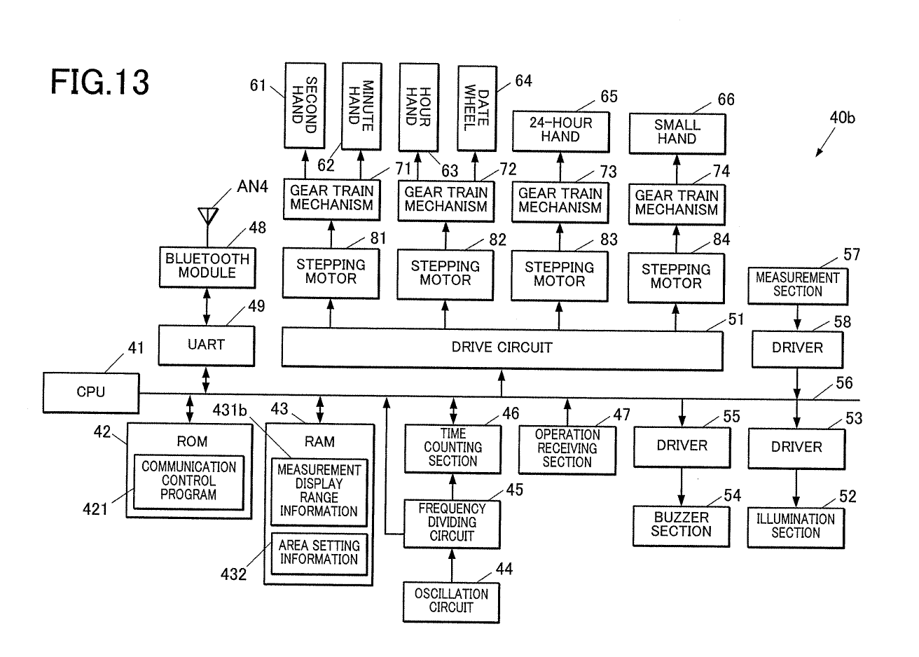

FIG. 13 is a block diagram showing the functional configuration of the analog electronic timepiece 40b in the modification example 2.

The analog electronic timepiece 40b in the modification example 2 has a configuration in which a measurement section 57 and a driver thereof 58 are added to the analog electronic timepiece 40, and the RAM 43 stores measurement display range information 431b instead of the sunrise sunset information 431. The other configuration is similar to that of the analog electronic timepiece 40, and thus, same reference numerals are provided to the same components to omit explanation thereof.

The measurement section 57 has a sensor which measures predetermined physical quantity. Though not especially limited, the sensor includes one or a plurality of sensors among known temperature sensors and air pressure sensors, for example. The driver 58 controls the operations of the sensors to operate sensors at predetermined time intervals according to the control by the CPU 41 and output measurement values measured by the sensors to the CPU 41 in a predetermined format.

The measurement display range information 431b includes setting according to the upper limit value (maximum value) and lower limit value (minimum value) of measurement value in a case of displaying the measurement result in the small window 402 by the small hand 66. The CPU 41 relativizes the measurement value between the determined upper limit value and the lower limit value to display the relative value within the display range of 180 degrees. That is, the analog electronic timepiece 40b in the modification example 2 displays the measurement value by a sensor in a form of relative value between a preset upper limit value and lower limit value, not in a form of absolute value.

The analog electronic timepiece 40 can acquire the upper and lower limit values from the smartphone 10 in advance. The setting operation of upper and lower limit values and the acquisition operation of setting values may be performed in a similar way to that of sunrise sunset information in the embodiment. Alternatively, the upper and lower limit values may be set by manual input of user via the operation receiving section 18 of the smartphone 10. In these cases, it is preferable that the upper and lower limit values are in a range expected by the user. For example, in a case where upper and lower limit values are automatically set for a temperature, the upper and lower limit values are determined so that discomfort index and such like are in a predetermined reference range while centering the average temperature of the present day which was acquired according to the date and current position. Alternatively, room temperature may be used as a reference instead of outside temperature to determine a normally appropriate range while centering a setting temperature of air conditioner which is desirable for the present date. A first measurement value (initial value) in continuous measurement may be centered to determine a preset range and display the change from the initial value.

The value to be displayed is not necessarily a relative value of measurement value itself, and may be a value subjected to correction conversion processing by the CPU 41. For example, in a case where an air pressure value is measured, the air pressure value can be converted into an altitude value and displayed as altitude information. In this case, by setting the upper and lower limit altitude values to respective altitudes of the highest point and the lowest point of user's climbing route, the user can sensuously acquire the present point in the climbing course.

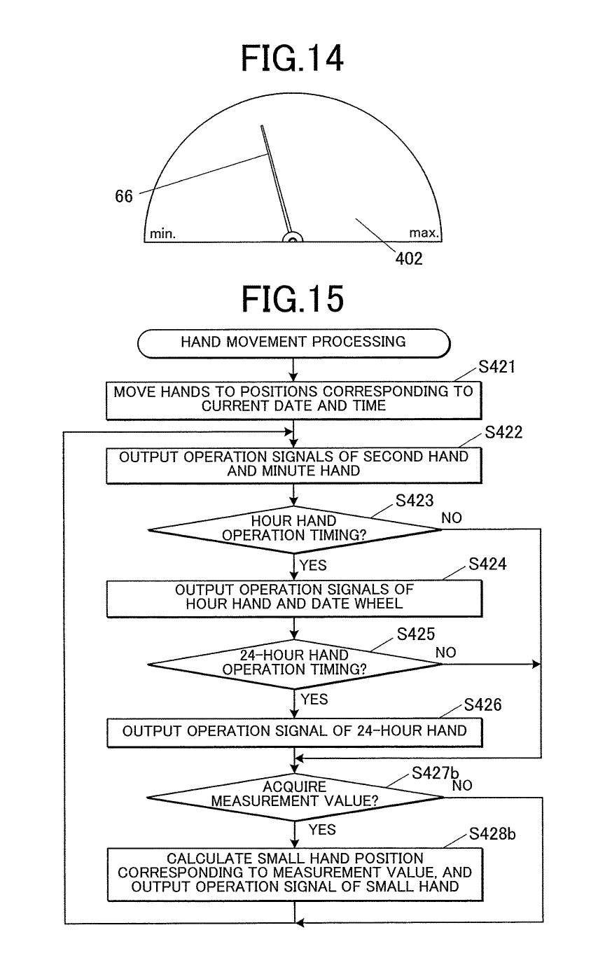

FIG. 14 is a view showing a display example in the small window 402 of the analog electronic timepiece 40b in the modification example 2.

The small hand 66, which is a tapered hand, indicates that the measurement value is a set lower limit value by pointing to the left end (9 o' clock direction) of small window 402 and indicates that the measurement value is an upper limit value by pointing to the right end (3 o' clock direction) of small window 402. Also in this case, the absolute values of upper and lower limit values are not indicated, and a relative position between the upper limit value and the lower limit value is indicated by the small hand 66 to enable the user to sensuously acquire the degree of measurement value.

FIG. 15 is a flowchart showing a control procedure by the CPU 41 of hand, movement processing executed in the analog electronic timepiece 40b in the modification example 2.

The hand movement processing is similar to that of the embodiment except for that the processing of steps S427 to S430 in the hand movement processing shown in FIG. 8 is replaced with the processing of steps S427b and S428b, and same reference numerals are provided to the same processing contents to omit detailed explanation thereof.

When the processing in step S423 proceeds to “NO”, when the processing in step S425 proceeds to “NO” and when the processing proceeds to step S427b after the processing of step S426, the CPU 41 determines whether the measurement value is acquired from the measurement section 57 (step S427b) If it is not determined that the measurement value is acquired (step S427b: NO), the processing of CPU 41 returns to step S422.

If it is determined that the measurement value is acquired (step S427b: YES), the CPU 41 calculates the pointing position of small hand 66 corresponding to the relative value of measurement value with respect to the upper and lower limit values by referring to the measurement display range information 431b, and outputs a control signal for moving the small hand 66 to the pointing position to the drive circuit 51 (step S428b) The processing of CPU 41 returns to step S422.

As described above, the analog electronic timepiece 40b in the modification example 2 includes a measurement section 57 which measures predetermined physical quantity. Each time the measurement section 57 acquires a measurement value of physical quantity, the CPU 41 calculates the relative hand position corresponding to the relative value of the measurement value with respect to the set upper and lower limit values, and moves the small hand 66 to the relative hand position.

That is, relative display can also be performed for the measurement value such as space physical quantity in a similar way, not only for the relative time elapse. Accordingly, a relative proceeding degree of a movement distance and such like can be easily acquired. Furthermore, the above-mentioned configuration can also be used to make the user easily acquire the situation in a case of indicating a deviation direction or degree with respect to a central value or a reference value, for example, a setting value of speed, temperature and such like not only indicating a proportion to the whole.

The present invention is not limited to the above embodiment, and various changes can be made.

For example, in the embodiment, the small hand 66 performs display in the semicircle small window 402; however, the shape of small window 402 is not limited to this. The display can be performed within an appropriate angle range. The operation range of small hand 66 is also not limited to the inside of small window 402, and the rotation operation may be performed around a nearly center of dial plate 400 as a rotation axis similarly to the hands 61 to 63 or by any one of the hands 61 to 63. Even when the operation range is 180 degrees (semicircle), the operation range is not limited to the range from 9 o'clock to 3 o'clock, and may be arbitrarily determined to the range of 12 o'clock to 6 o'clock, for example.

In the embodiment, the small hand 66 can be rotated 360 degrees; however, the small hand 66 may be allowed to rotate only in the range of 180 degrees within the range of small window 402. In this case, the small hand 66 may be fast-forwarded to return to the sunset position at an appropriate timing after the sunset.

In the embodiment, the small hand 66 is operated at respective predetermined drive intervals during daytime and nighttime; however, the present invention is not limited to this. For example, the drive interval may be varied according to user's sense by setting a short drive interval for each 60 degree range near the sunrise and sunset, and setting a long drive interval for 60 degree range near the zenith.

In the embodiment, the sunrise and sunset times and upper and lower limit values of display according to measurement values of the measurement section 57 are acquired to be set from the smartphone 10; however, the above times and values may be set according to an instruction received by the operation receiving section 47 of the analog electronic timepiece 40. The timing to acquire the setting from the smartphone 10 may also be appropriately set. For example, when relative display is performed on the basis of a measurement value obtained by the measurement section 57, the settings may be acquired at a predetermined time interval from the start or start time only when the measurement section 57 is operated. The sunrise and sunset times are not limited to those of the current position and current date and time, and sunrise and sunset times of other desired areas and timings may be set to be displayed.

The acquisition of information from the smartphone 10 is not limited to the communication by Bluetooth. For example, proximity wireless communication using RFID tag and wired communication may be used.

The embodiment has been described by taking, as an example, the analog electronic timepiece 40 performing only the analog display; however, the present invention can also be similarly applied to an analog electronic timepiece using the digital display in addition to analog display.

In the embodiment, the CPU 41 performs all the control operations by software control as operation of processor; however, a part of the control operations may be executed by using hardware such as a dedicated logic circuit.

The analog display device according to the present invention is not limited to the analog electronic timepiece. The present invention can be applied to any timepiece as long as it can display a relative value according to a measurement value by using a hand.

The other details such as specific configurations, operation contents and procedures shown in the embodiments can be appropriately changed within the scope of the present invention.

Though several embodiments of the present invention have been described above, the scope of the present invention is not limited to the above embodiments, and includes the scope of inventions, which is described in the scope of claims, and the scope equivalent thereof.

The entire disclosure of Japanese Patent Application No. 2015-172635 filed on Sep. 2, 2015 including description, claims, drawings, and abstract are incorporated herein by reference in its entirety.

What is claimed is:

1. An analog display device, comprising:
a hand which is rotatable;
a dial plate which defines a pointing position of the hand;
a measurement section which acquires a measurement value according to a determined measurement target; and
a processor which moves the hand to a hand position between a first position and a second position which are defined on the dial plate, the hand position being determined according to the measurement value,
wherein
the processor sets a first setting value corresponding to the first position and a second setting value corresponding to the second position to be variable, and moves the hand to a relative hand position corresponding to a relative value of the measurement value with respect to the first setting value and the second setting value.

2. The analog display device according to claim 1, wherein
the measurement section includes a time counting section which counts current date and time,
the first setting value is predetermined start time, the second setting value is predetermined end time, and the measurement target is an elapsed time from the start time, and
the processor calculates a first drive interval for moving the hand by a predetermined angle, and moves the hand by the predetermined angle from the first position at the first drive interval from the start time.

3. The analog display device according to claim 2, wherein
the hand is rotatable in at least a predetermined rotation direction on the dial plate, and
the processor calculates a second drive interval for moving the hand in the predetermined rotation direction by the predetermined angle from the second position to the first position from the end time to next start time, and moves the hand by the predetermined angle at the second drive interval from the end time.

4. The analog display device according to claim 3, further comprising a covering plate which is provided with an opening partially exposing the dial plate and the hand, wherein the opening exposes a movement operation of the hand from the first position to the second position in the predetermined rotation direction.

5. The analog display device according to claim 2, wherein the start time is sunrise time at a predetermined position, and the end time is sunset time at the predetermined position.

6. The analog display device according to claim 3, wherein the start time is sunrise time at a predetermined position, and the end time is sunset time at the predetermined position.

7. The analog display device according to claim 4, wherein the start time is sunrise time at a predetermined position, and the end time is sunset time at the predetermined position.

8. The analog display device according to claim 1, wherein the first position and the second position are determined to be located in 180-degree opposite sides with respect to a rotation axis of the hand.

9. The analog display device according to claim 2, wherein the first position and the second position are determined to be located in 180-degree opposite sides with respect to a rotation axis of the hand.

10. The analog display device according to claim 3, wherein the first position and the second position are determined to be located in 180-degree opposite sides with respect to a rotation axis of the hand.

11. The analog display device according to claim 8, wherein the first position is located in 9 o'clock direction with respect to a predetermined reference location direction of the dial plate, and the second position is located in 3 o'clock direction with respect to the reference location direction.

12. The analog display device according to claim 8, wherein ends of the hand point to respective two points in 180-degree opposite directions with respect to the rotation axis of the hand, and the ends are different in at least one of shape, size, color, pattern and distance from the rotation axis.

13. The analog display device according to claim 11, wherein ends of the hand point to respective two points in 180-degree opposite directions with respect to the rotation axis of the hand, and the ends are different in at least one of shape, size, color, pattern and distance from the rotation axis.

14. The analog display device according to claim 1, wherein
the measurement section measures predetermined physical quantity, and
each time a measurement value of the physical quantity is acquired from the measurement section, the processor calculates the relative hand position and moves the hand to the relative hand position.

15. The analog display device according to claim 1, further comprising a communication section which performs communication with an external device, wherein the processor acquires information regarding the first setting value and the second setting value from the external device with the communication section.

16. The analog display device according to claim 2, further comprising a communication section which performs communication with an external device, wherein the processor acquires information regarding the first setting value and the second setting value from the external device with the communication section.

17. The analog display device according to claim 3, further comprising a communication section which performs communication with an external device, wherein the processor acquires information regarding the first setting value and the second setting value from the external device with the communication section.

18. The analog display device according to claim 15, wherein
the first setting value and the second setting value vary according to time elapse, and
the processor acquires the first setting value and the second setting value from the external device with the communication section at a predetermined setting interval.

19. The analog display device according to claim 1, wherein
the measurement section includes a time counting section which counts current date and time, and
the analog display device is an electronic timepiece which includes a time hand displaying the current date and time.

20. The analog display device according to claim 2, wherein
the measurement section includes a time counting section which counts current date and time, and
the analog display device is an electronic timepiece which includes a time hand displaying the current date and time.
